(19) United States
(12) Patent Application Publication
(10) Pub. No.: US 2025/0338011 A1
(43) Pub. Date: Oct. 30, 2025

(54) IMAGE PICKUP APPARATUS

(71) Applicant: CANON KABUSHIKI KAISHA, Tokyo (JP)

(72) Inventor: TAKAYUKI IWASA, Kanagawa (JP)

(21) Appl. No.: 19/077,245

(22) Filed: Mar. 12, 2025

(30) Foreign Application Priority Data
Apr. 24, 2024 (JP) 2024-070698

(51) Int. Cl. H04N 23/661; H04N 23/68

(52) U.S. Cl. CPC H04N 23/661; H04N 23/6812

(57) ABSTRACT

An image pickup apparatus includes a first member made of a conductive material, a second member made of a nonconductive material, a first antenna disposed between the first member and the second member and capable of wireless communication, and a second antenna disposed between the first member and the second member and capable of the wireless communication. The first antenna has a first surface that has a first pattern and is orthogonal to an optical axis direction. The second antenna has a second surface that has a second pattern and is tilted relative to the first surface. The first antenna and the second antenna are arranged so that the first antenna and the second antenna do not overlap each other when viewed from the optical axis direction and when viewed from a direction orthogonal to the second surface.

### BACKGROUND

### Technical Field

The present disclosure relates to an image pickup apparatus having an antenna for transmitting and receiving radio waves such as wireless communication.

### Description of Related Art

An image pickup apparatus having an antenna for transmitting images to the outside via wireless communication has conventionally been known (see Japanese Patent No. 7009589).

A wireless communication technology called Multi Input Multi Output (referred to as MIMO hereinafter) has recently been used, which can increase a data amount handled in a certain period by transmitting and receiving data using a plurality of antennas. Japanese Patent No. 7009589 does not describe the arrangement of the plurality of antennas suitable for MIMO. Since MIMO uses a plurality of antennas for communication, closely placing the antennas for size reduction of the system may cause radio interference and may not provide sufficient wireless communication performance.

### SUMMARY

An image pickup apparatus according to one aspect of the disclosure includes a first member made of a conductive material, a second member made of a nonconductive material, a first antenna disposed between the first member and the second member and capable of wireless communication, and a second antenna disposed between the first member and the second member and capable of the wireless communication. The first antenna has a first surface that has a first pattern and is orthogonal to an optical axis direction. The second antenna has a second surface that has a second pattern and is tilted relative to the first surface. The first antenna and the second antenna are arranged so that the first antenna and the second antenna do not overlap each other when viewed from the optical axis direction and when viewed from a direction orthogonal to the second surface.

Further features of various embodiments of the disclosure will become apparent from the following description of embodiments with reference to the attached drawings.

### BRIEF DESCRIPTION OF THE DRAWINGS

FIGS. 1A and 1B are external views of an image pickup apparatus according to a first embodiment.

FIG. 2 is a block diagram of the image pickup apparatus according to the first embodiment.

FIGS. 3A and 3B illustrate a structure of a top cover unit of the image pickup apparatus according to the first embodiment.

FIG. 4 illustrates a holding structure of a communication unit according to the first embodiment.

FIG. 5 illustrates an antenna structure of the communication unit according to the first embodiment.

FIGS. 6A and 6B illustrate a holding structure of the communication unit of the first embodiment.

FIG. 7 illustrates a correlation coefficient of the communication unit according to the first embodiment.

FIG. 8 is a sectional view taken along a line A-A in FIG. 3A.

FIGS. 9A to 9D illustrate an example orientation for holding the image pickup apparatus according to the first embodiment.

FIG. 10 illustrates the image pickup apparatus according to a second embodiment attached to a tripod.

FIG. 11 explains a first communication unit and a second communication unit according to the second embodiment attached to a grip portion.

FIGS. 12A and 12B are exploded perspective views illustrating a structure of the image pickup apparatus according to a third embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### First Embodiment

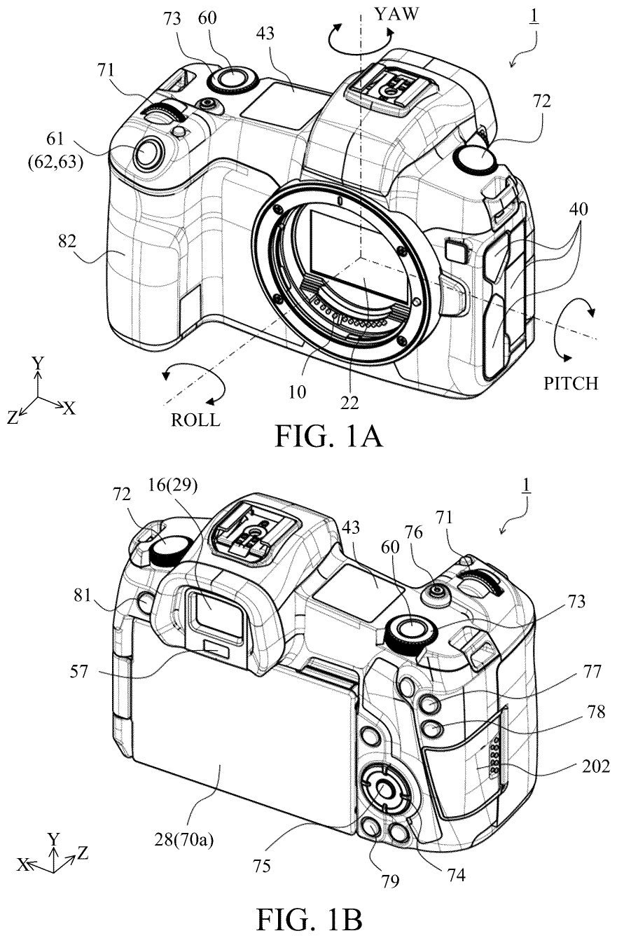

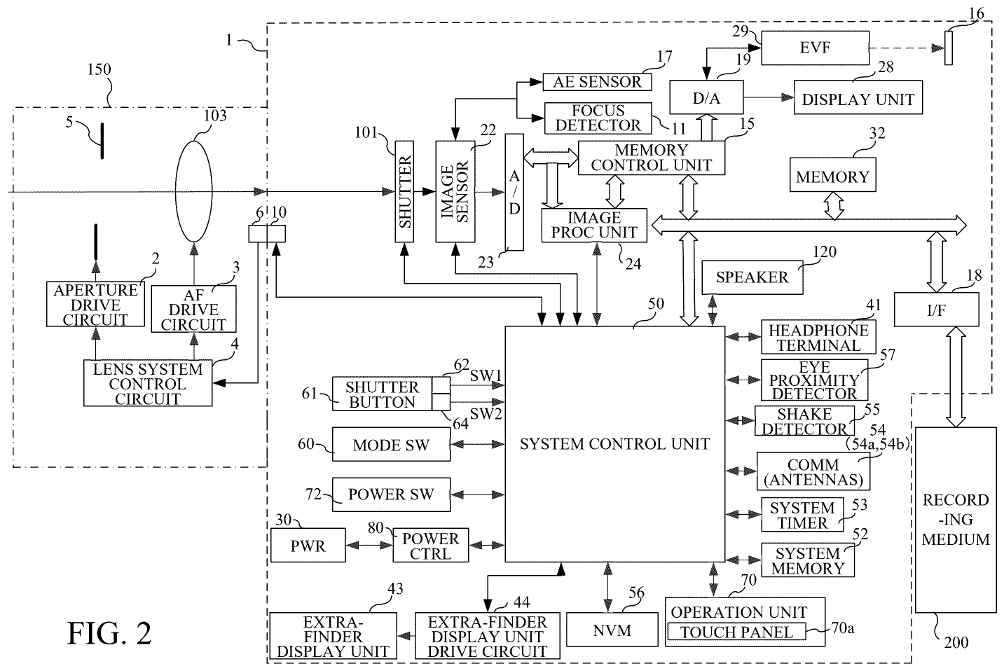

FIGS. 1A and 1B are external views of a digital camera 1 as an example of an image pickup apparatus according to this embodiment. FIGS. 1A and 1B are front and rear perspective views of the digital camera 1, respectively. FIG. 2 is a block diagram of the digital camera 1.

A display unit 28 is provided on the rear surface of a digital camera 1 and displays images and various information. A touch panel 70a can detect touch operations on the display surface (operation surface) of the display unit 28.

A terminal cover 40 protects connectors such as a headphone terminal 41 that connects an external device to the digital camera 1. By connecting headphones to the headphone terminal 41, electronic sounds from the digital camera 1 can be heard through the headphones.

An extra-finder display unit 43 is provided on the top surface of the digital camera 1 and displays various settings of the digital camera 1, such as a shutter speed and an F-number (aperture value).

A mode switch 60 is an operation unit for switching between various modes.

A shutter button 61 is an operation unit for issuing an imaging instruction, and is a switch with a two-step detector in the pressing direction. When the shutter button 61 detects the first turning-on position, an autofocus (AF) operation is performed, and when the shutter button 61 detects the second turning-on position, an imaging operation is performed. The operation when the first turning-on position is detected can be changed by using the function for customizing the operation buttons. For example, an auto-exposure (AE) operation without performing an AF operation can be performed.

A main electronic dial 71 is a rotary operation member included in an operation unit 70. Rotating the main electronic dial 71 can change the settings such as the shutter speed and F-number.

The operation members such as the push buttons and dials illustrated in FIGS. 1A and 1B are included in the operation unit 70 illustrated in FIG. 2.

A power switch 72 is used to switch between the power-on and power-off of the digital camera 1.

A sub electronic dial 73 is a rotary operation member, and is used to move a selection frame, feed images, etc.

A moving image button 76 is used to start and stop capturing (recording) a moving image.

An AE lock button 77 can be pressed in the imaging standby state to fix the exposure state.

An enlargement button 78 is used to turn on and off an enlargement mode in the live-view (LV) display in the imaging mode. Turning on the enlargement mode and then operating the main electronic dial 71 can enlarge or reduce the LV image. The enlargement button 78 is used to increase the magnification of the playback image in the playback mode.

A playback button 79 is used to switch between the imaging mode and the playback mode. Pressing the playback button 79 during the imaging mode can change the imaging mode to the playback mode, and the latest image recorded on a recording medium 200 can be displayed on the display unit 28.

A menu button 81 is used to display a menu screen on the display unit 28 where various settings can be made. A cross button 74 includes at least up, down, left, and right buttons. A setting button 75 is mainly used to finalize a selected item. The user (photographer) can intuitively make various settings using the menu screen displayed on the display unit 28, the setting button 75, and the cross button 74.

An eyepiece finder (peep type finder) includes an eyepiece unit 16 and an electronic viewfinder (EVF) unit 29 provided inside. The user can view an image displayed on the EVF unit 29 through the eyepiece unit 16.

An eye proximity detector 57 is an eyepiece detecting sensor (proximity detecting sensor) configured to detect whether the user has placed his/her eye on the eyepiece unit 16, and is provided inside the eyepiece unit 16.

A speaker 120 can play a specific electronic sound or play the audio in captured video data based on instructions from a system control unit 50.

A lid 202 is a lid for a slot that houses the recording medium 200.

A grip portion 82 has a shape that protrudes toward the object side from the imaging surface so that the user can comfortably perform imaging.

A lens unit 150 includes a lens 103, and is attachable to and detachable from the digital camera 1. The lens 103 usually includes a plurality of lenses, but FIG. 2 illustrates a single lens for simplicity purposes.

A lens-side communication terminal 6 is used when the lens unit 150 communicates with the digital camera 1. A camera-side communication terminal 10 is used when the digital camera 1 communicates with the lens unit 150.

The lens unit 150 communicates with the system control unit 50 via the lens-side communication terminal 6 and the camera-side communication terminal 10. The lens system control circuit 4 controls an aperture stop 5 via an aperture drive circuit 2, and performs focusing by changing the position of the lens 103 via an AF drive circuit 3.

An AE sensor 17 measures the luminance of an object through the lens unit 150.

A focus detector 11 outputs defocus amount information to the system control unit 50. The system control unit 50 controls the lens unit 150 based on the defocus amount information and performs phase-difference AF. The focus detector 11 may be a dedicated phase-difference sensor, or may be configured as an imaging-surface phase-difference sensor of an image sensor 22.

A shutter 101 is a focal plane shutter for controlling the exposure time of the image sensor 22 under the control of the system control unit 50.

The image sensor 22 includes a CCD or CMOS element, and converts an optical image of an object into an electrical signal. The aspect ratio of the image sensor 22 is 3:2 or 4:3, and the longitudinal direction (X direction) of the digital camera 1 coincides with the longitudinal direction of the image sensor 22.

An λ/D converter 23 converts an analog signal output from the image sensor 22 into a digital signal.

An image processing unit 24 performs predetermined pixel interpolation, resizing processing such as reduction, and color conversion processing for the data from the λ/D converter 23 or the data from a memory control unit 15. The image processing unit 24 performs predetermined calculation processing using captured image data. The system control unit 50 performs exposure control and focus detection control based on the calculation result obtained by the image processing unit 24.

The output data from the λ/D converter 23 is written into a memory 32 via the image processing unit 24 and the memory control unit 15, or via the memory control unit 15.

The memory 32 stores image data obtained by the image sensor 22 and converted into digital data by the λ/D converter 23, and image data to be displayed on the display unit 28 and the EVF unit 29. The memory 32 has a storage capacity sufficient to store a predetermined number of still images and a predetermined period of moving images and audio. The memory 32 also serves as an image display memory (video memory).

A D/A converter 19 converts the image display data stored in the memory 32 into an analog signal and outputs it to the display unit 28 and the EVF unit 29. The display unit 28 and the EVF unit 29 perform display according to the analog signal from the D/A converter 19 on a display device such as an LCD or an organic EL.

The setting values of the shutter speed, F-number, and the like are displayed on the extra-finder display unit 43 via an extra-finder display unit drive circuit 44.

A nonvolatile memory (NVM) 56 is an electrically erasable and recordable memory, and may be, for example, an EEPROM. The nonvolatile memory 56 stores constants and programs for the operation of the system control unit 50.

The system control unit 50 includes at least one processor or circuit, and controls the entire digital camera 1. The system control unit 50 executes programs recorded in the nonvolatile memory 56 and achieves each processing according to this embodiment, which will be described later. The system control unit 50 also performs display control by controlling the memory 32, the D/A converter 19, the display unit 28, etc.

A system memory 52 may be, for example, a RAM, in which constants and variables for the operation of the system control unit 50, and programs read from the nonvolatile memory 56, etc. are loaded.

A system timer 53 measures the time for various controls and the time of the built-in clock.

The mode switch 60, a first shutter switch 62, a second shutter switch 63, and the operation unit 70 are used to input various operation instructions to the system control unit 50.

The mode switch 60 changes the operation mode of the system control unit 50 to one of a still image capturing mode, a moving image capturing mode, a playback mode, etc. Modes included in the still image capturing mode include an auto-imaging mode, an auto-scene determination mode, a manual mode, an aperture priority mode (Av mode), a shutter-speed priority mode (Tv mode), and a program AE mode (P mode). There are also various scene modes and custom modes that are imaging settings for each imaging scene. The user can directly switch to one of these modes using the mode switch 60. After switching to a list screen of imaging modes with the mode switch 60, one of a plurality of displayed modes may be selected and switched using other operation members. Similarly, the moving image capturing mode may also include multiple modes.

The first shutter switch 62 is turned on while the shutter button 61 provided on the digital camera 1 is being operated or so-called half-pressed (imaging preparation instruction), and generates a first shutter switch signal SW1. The system control unit 50 starts an imaging preparation operation such as AF processing, AE processing, auto white balance (AWB) processing, and flash pre-flash (EF) processing based on the first shutter switch signal SW1.

The second shutter switch 63 is turned on when the shutter button 61 is completely operated or so-called fully pressed (imaging instruction), and generates a second shutter switch signal SW2. The system control unit 50 starts a series of imaging processing operations, from reading a signal from the image sensor 22 to writing a captured image into the recording medium 200 as an image file, according to the second shutter switch signal SW2.

The operation unit 70 is the various operation members described above as an input unit that accepts operations from the user.

A power control unit 80 includes a battery detection circuit, a DC-DC converter, and a switch circuit that switches the blocks to be powered, and detects whether a battery is installed, the type of battery, and the remaining battery level. The power control unit 80 also controls the DC-DC converter based on the detection result and instruction from the system control unit 50, and supplies the required voltage to each unit including the recording medium 200 for the required period.

A power supply unit 30 includes a primary battery such as an alkaline battery and a lithium battery, a secondary battery such as a NiCd battery, a NiMH battery, and a Li battery, and an AC adapter.

A recording medium interface (I/F) 18 is an interface with the recording medium 200 such as a memory card or a hard disk drive.

The recording medium 200 is a recording medium such as a memory card for recording captured images, and includes a semiconductor memory or a magnetic disk.

The communication unit 54 includes a first communication unit (first antenna) 54a and a second communication unit (second antenna) 54b, and is connected to an external device wirelessly or by a wired cable to transmit and receive video signals and audio signals. More specifically, the communication unit 54 can transmit images (including LV images) captured by the image sensor 22 and images recorded in the recording medium 200, and can receive images and various other information from external devices. The communication unit 54 can be connected to a wireless Local Area Network (LAN) and the Internet, and is also compatible with MIMO, a wireless communication technology that transmits and receives data using a plurality of antennas. The communication unit 54 can also communicate with external devices using Bluetooth (registered trademark) or Bluetooth Low Energy.

A shake detector 55 can be an acceleration sensor or a gyro sensor, and can detect the movement of the digital camera 1 (pan, tilt, lift, whether or not it is stationary, etc.). The shake detector 55 detects the shake of the digital camera 1 in three axial directions: the pitch direction around the pitch axis, the yaw direction around the yaw axis, and the roll direction around the roll axis of the digital camera 1. The shake detector 55 outputs a signal (angular velocity signal) indicating the angular velocity of the vibration of the digital camera 1, and the system control unit 50 calculates the magnitude of the vibration amount of the digital camera 1 from the angular velocity signal. The system control unit 50 moves the image sensor 22 in a plane orthogonal to the optical axis according to the calculated vibration amount to perform optical image stabilization. The system control unit 50 can determine whether the image captured by the image sensor 22 was captured with the digital camera 1 held horizontally or vertically based on the signal detected by the shake detector 55.

The eye proximity detector 57 detects the proximity (approach) and departure (separation) of the eye (object) to the eyepiece unit 16. The system control unit 50 switches the display unit 28 and the EVF unit 29 between display (display state) and non-display (non-display state) according to the state detected by the eye proximity detector 57. More specifically, at least in the imaging standby state, and in a case where the display destination switching is automatic switching and the eye is not placed near the object, the display destination is set to the display unit 28 and the display is turned on, and the EVF unit 29 is turned off. In the case of the proximity of the eye, the display destination is set to the EVF unit 29 and the display is turned on, and the display unit 28 is turned off.

The touch panel 70a and the display unit 28 can be integrated. For example, the touch panel 70a is configured so that the light transmittance does not interfere with the display of the display unit 28, and is attached to the upper layer of the display surface of the display unit 28. Then, the input coordinates on the touch panel 70a are associated with the display coordinates on the display surface of the display unit 28. Thereby, a Graphical User Interface (GUI) can be provided that allows the user to directly operate the screen displayed on the display unit 28.

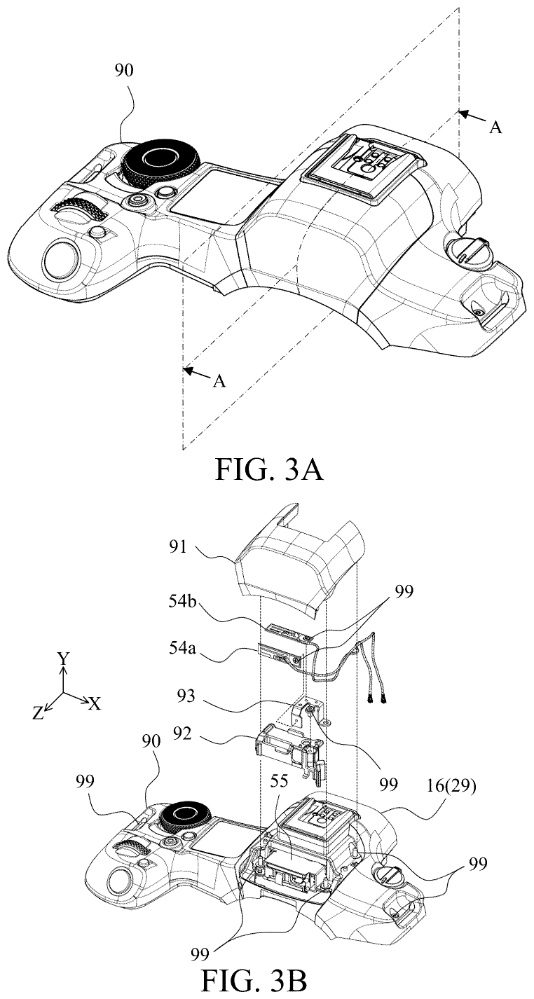

A description will now be given of the holding structure of the first communication unit 54a and the second communication unit 54b in this embodiment with reference to FIGS. 3A and 3B. FIGS. 3A and 3B illustrate the structure of the top cover unit of the digital camera 1. FIGS. 3A and 3B are an assembled view and an exploded perspective view of the top cover unit, respectively.

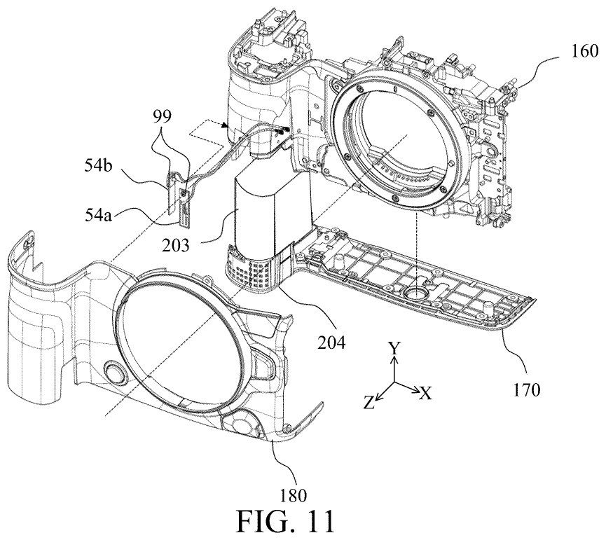

A top cover 90 is an exterior member molded from a conductive material such as conductive resin or magnesium alloy, and is connected with screws 99 to a main chassis 160 (illustrated in FIG. 11) molded from a conductive material such as conductive resin or magnesium alloy.

An antenna cover 91 is a cover member molded from a nonconductive resin material and covers a part of the top cover 90. The antenna cover 91 is fixed to the upper part of the top cover 90 with screws 99. Space is formed between the top cover 90 and the antenna cover 91 to house the first communication unit 54a and the second communication unit 54b.

The first communication unit 54a and the second communication unit 54b are included in the communication unit 54 and are capable of wireless communication. The first communication unit 54a and the second communication unit 54b are disposed at a position away from the optical-axis center of the image sensor 22 and on the object side of the eyepiece unit 16 (EVF unit 29) through which the user views the object.

The first communication unit 54a is disposed so that the substrate surface (first surface) on which the antenna pattern (first pattern) is wired is orthogonal to the optical axis direction (Z direction). The first communication unit 54a is disposed so that the longitudinal direction of the antenna pattern is the same as the longitudinal direction (X direction) of the digital camera 1 (image sensor 22). Here, “orthogonal” includes not only strictly orthogonal, but also substantially orthogonal (approximately orthogonal). Furthermore, “same” includes not only strictly identical, but also substantially identical (approximately identical).

The second communication unit 54b is disposed so that the substrate surface (second surface) on which the antenna pattern (second pattern) is wired is tilted relative to a direction (Y-axis direction) orthogonal to the optical axis direction on the basis of the first communication unit 54a. The tilt angle may be any angle as long as the correlation coefficient (described later) can satisfy the communication performance, such as 90 degrees±30 degrees. The tilt angle may be 90 degrees±10 degrees, or 90 degrees. Here, 90 degrees includes not only strictly 90 degrees, but also substantially 90 degrees (approximately 90 degrees). In this embodiment, the second communication unit 54b is disposed so that the substrate surface (second surface) on which the antenna pattern (second pattern) is wired is tilted relative to the direction (Y-axis direction) orthogonal to the optical axis direction on the basis of the first communication unit 54a. The second communication unit 54b is disposed so that the longitudinal direction of the antenna pattern is the same as the longitudinal direction of the digital camera 1 (image sensor 22).

The shake detector 55 is housed in an area where the directions orthogonal to the substrate surfaces of the first communication unit 54a and the second communication unit 54b (Z-axis direction and Y-axis direction) intersect, which is inside (−Y-axis side) of the space in which the first communication unit 54a and the second communication unit 54b are housed. Thereby, the antenna can be efficiently housed inside the digital camera 1.

An antenna fixing member 92 is a nonconductive member molded from a nonconductive resin material. A conductive plate 93 is a sheet metal member made of a conductive material such as an aluminum alloy, stainless steel, or copper plate. The conductive plate 93 is disposed between the antenna fixing member 92, and the first communication unit 54a and the second communication unit 54b, and is fixed with the screw 99. The conductive plate 93 is electrically connected to ground patterns 548 (illustrated in FIG. 5) of the first communication unit 54a and the second communication unit 54b. The conductive plate 93, the first communication unit 54a, and the second communication unit 54b are fastened to the top cover 90 with the screws 99, and are electrically connected to the top cover 90.

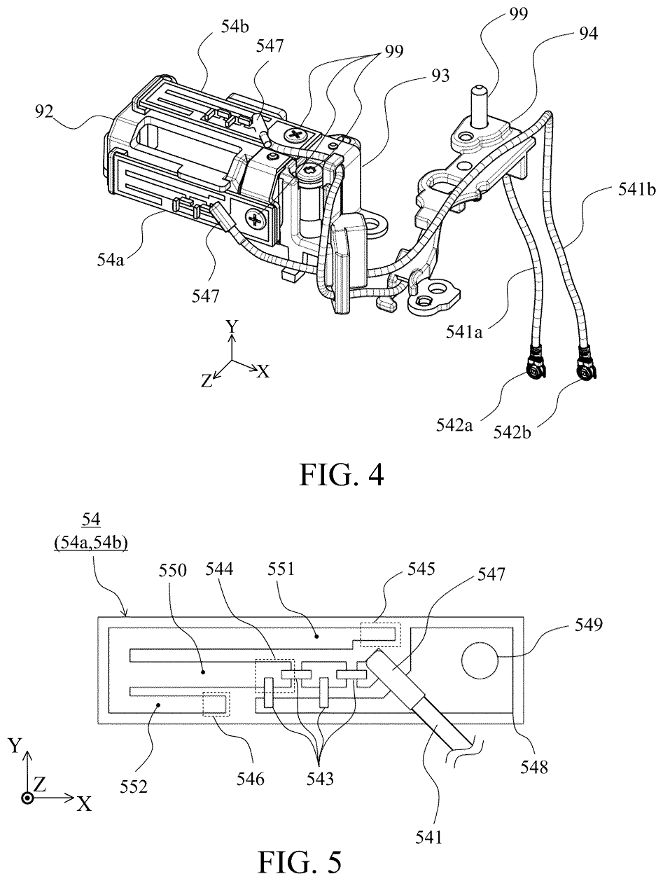

Referring now to FIG. 4, a description will be given of a structure (antenna unit) in which the first communication unit 54a and the second communication unit 54b are attached to the antenna fixing member 92 in this embodiment. FIG. 4 illustrates a holding structure for the first communication unit 54a and the second communication unit 54b.

The first communication unit 54a and the second communication unit 54b include coaxial cables 541a and 541b, respectively. Coaxial connectors 542a and 542b are provided at the tips of the coaxial cables 541a and 541b, respectively. The coaxial connectors 542a and 542b are connected to an unillustrated main board (system control unit 50), and the system control unit 50 can perform the desired communication and control. A coaxial cable holding member 94 is molded from a nonconductive resin and is used to attach the coaxial cables 541a and 541b to the top cover 90. The coaxial cable 541a is wired between the top cover 90 and the coaxial cable holding member 94. The coaxial cable 541b is wired to the coaxial cable holding member 94 so that it does not fall off from the coaxial cable holding member 94 under its own weight.

A coaxial cable is a noise-resistant electric wire in which the conductor wire through which a signal passes is covered with an insulator, and the conductor wire is further covered with a ground (GND) conductor. If a plurality of coaxial cables are arranged parallel to each other for a long distance in contact with each other, both signals may cause radio wave interference. Accordingly, the coaxial cable holding member 94 may be provided between the coaxial cables 541a and 541b to prevent the coaxial cables from contacting each other. Thereby, a higher shielding effect for the coaxial cables can be obtained and the risk of radio wave interference between the coaxial cables can be reduced.

A description will now be given of an antenna structure according to this embodiment with reference to FIG. 5. FIG. 5 illustrates the antenna structure of the communication unit 54, and is a front view of a substrate on which an antenna pattern is wired.

The communication unit 54 transmits a signal from the unillustrated main substrate through a coaxial cable 541, and transmits the signal to a matching component 543 of the communication unit 54 through a solder connector 547. A ground shield portion covering the outer circumference of the coaxial cable 541 is connected to the ground pattern 548 through the solder connector 547.

The matching component 543 adjusts the signal (current) transmitted through the coaxial cable 541 so that the impedance of the antenna has a desired value. Adjusting the impedance of the antenna with the matching component 543 can make the transmitted signal (current) less likely to be reflected. For example, even if the first communication unit 54a and the second communication unit 54b have the same pattern and the same substrate layer structure, the matching component 543 may be set to an optimal impedance value depending on the attachment location.

A first transmitter 545 and a second transmitter 546 are oscillation points that oscillate the current supplied to the power supply unit 544 as radio waves.

A power supply pattern 550 is an antenna pattern that supplies current from the power supply unit 544 to the first transmitter 545 and the second transmitter 546.

A first antenna pattern 551 is an antenna pattern from the power supply pattern 550 to the first transmitter 545, and has a wiring length suitable for the 2.4 GHz frequency band.

A second antenna pattern 552 is an antenna pattern from the power supply pattern 550 to the second transmitter 546, and has a wiring length suitable for the 5.0 GHz frequency band. Thus, each of the first pattern and the second pattern has a first antenna pattern and a second antenna pattern, and the first antenna pattern and the second antenna pattern are adjusted to different frequencies.

A ground connector 549 is a hole that penetrates through the substrate, and is used to connect the communication unit 54 to the top cover 90 with the screws 99. The top cover 90 is connected to the main chassis 160 (illustrated in FIG. 11) with the screws 99. The main chassis 160 is connected to all conductive members of the digital camera 1, so the ground pattern 548 has an electrical characteristic as so-called earth.

The antenna pattern length from the power supply unit 544 to the first transmitter 545 and the antenna pattern length from the power supply unit 544 to the second transmitter 546 are λ/4, where λ is a wavelength of the radio wave of the set frequency. Where f is a set frequency and v is a propagation speed, the antenna pattern length can be calculated from the following equation.

$$f = \frac{v}{λ}$$

In this embodiment, the communication unit 54 has two antennas, one for 2.4 GHz and one for 5.0 GHz. Each antenna is a so-called monopole antenna, with the first end connected to the ground. The monopole antenna can be designed with a length of λ/4, which is half the length of a general dipole antenna, λ/2, so that the communication unit 54 can be designed to be small.

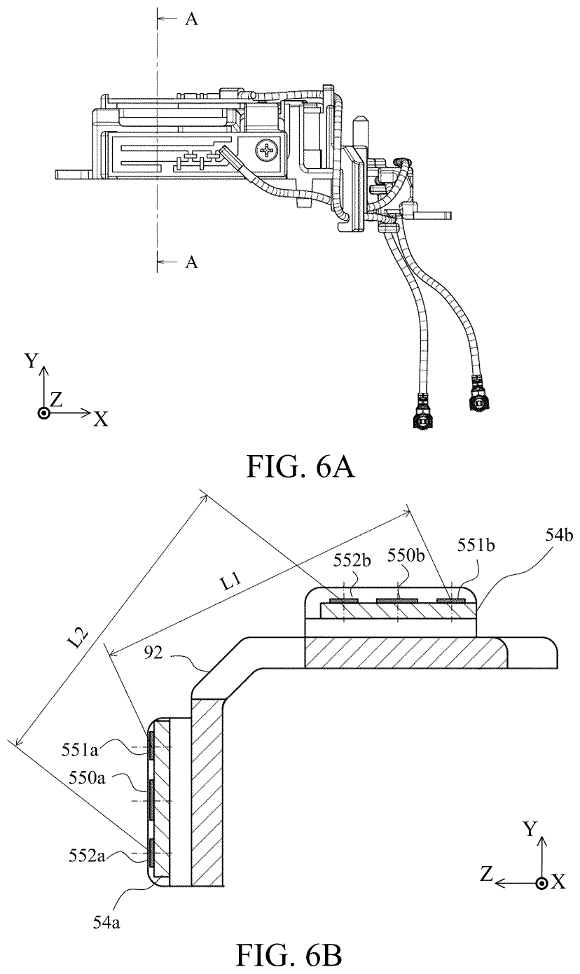

A description will now be given of a distance between the antenna patterns of the first communication unit 54a and the second communication unit 54b and the attachment structure with reference to FIGS. 6A and 6B. FIGS. 6A and 6B illustrate the holding structure of the communication unit 54. FIG. 6A is a front view of the antenna unit of FIG. 4. FIG. 6B is a sectional view taken along a line A-A in FIG. 6A. The position of the line A-A is the same as the sectional position in FIG. 3A.

The first communication unit 54a and the second communication unit 54b have the same structure as that of the communication unit 54 described in FIG. 5. In a case where the power supply pattern 550, the first antenna pattern 551, and the second antenna pattern 552 are attached at the position of first communication unit 54a in FIG. 6B, “a” is suffixed to each number. More specifically, they will be referred to as a power supply pattern 550a, a first antenna pattern 551a, and a second antenna pattern 552a in the following description. The power supply pattern 550a, the first antenna pattern 551a, and the second antenna pattern 552a constitute a first pattern formed in first communication unit 54a. Similarly, in a case where the communication unit 54 is attached at the position of the second communication unit 54b, “b” is suffixed to each number. More specifically, they will be referred to as a power supply pattern 550b, a first antenna pattern 551b, and a second antenna pattern 552b in the following description. The power supply pattern 550b, the first antenna pattern 551b, and the second antenna pattern 552b constitute a second pattern formed in the second communication unit 54b.

A spatial distance L1 is a distance between the first antenna pattern 551a included in the first pattern formed in the first communication unit 54a and a first antenna pattern 551b included in the second pattern formed in the second communication unit 54b. A spatial distance L2 is a distance between a second antenna pattern 552a included in the first pattern formed in the first communication unit 54a and a second antenna pattern 552b included in the second pattern formed in the second communication unit 54b.

As described above, the first antenna patterns 551a and 551b are antenna patterns suitable for 5.0 GHz, and the second antenna patterns 552a and 552b are antenna patterns suitable for 2.4 GHz.

In arranging a plurality of antennas, they may generally be separated from each other by a distance of λ/2 (λ/4 in the case of a monopole antenna). That is, from the relational expression of frequency f, propagation speed v, and wavelength λ, they may be separated by 31.25 mm (=λ/4) in the case of 2.4 GHZ, and by 15 mm (=λ/4) or more in the case of 5.0 GHz. However, in this case, the antennas cannot be housed in the space between the top cover 90 and the antenna cover 91, and the size of the digital camera 1 increases.

Accordingly, this embodiment sets the spatial distance L1 between the first antenna patterns to about 10 mm (=λ/6), and the spatial distance L2 between the second antenna patterns to about 10 mm (=λ/12.5). In a case where the spatial distances L1 and L2 are too close, the correlation coefficient becomes 1, and different antennas oscillate as if they were the same antenna.

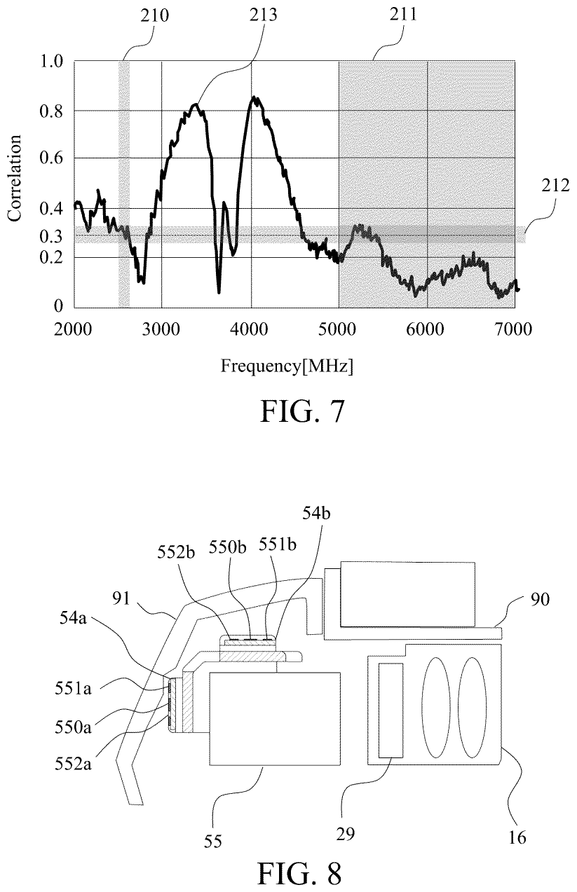

Referring now to FIG. 7, a description will be given of a correlation coefficient in a case where the first communication unit 54a and the second communication unit 54b are suitably arranged. FIG. 7 illustrates the correlation coefficient between the first communication unit 54a and the second communication unit 54b. The horizontal axis of FIG. 7 represents the frequency, and the vertical axis represents the correlation coefficient.

In a case where the correlation coefficient approaches 1, electromagnetic coupling occurs even with different communication units (antennas), and the antenna efficiency decreases. Thereby, the communication distance and communication capacity lower, and the system does not function as MIMO. Thus, as the correlation coefficient approaches 0, the communication efficiency of MIMO improves. In this embodiment, a plurality of communication units are arranged close to each other so as to function as MIMO.

A correlation coefficient 213 between the first communication unit 54a and the second communication unit 54b is approximately 0.3 in the 2.4 GHz frequency band that is widely used in the IEEE 802 standard. The correlation coefficient 213 is approximately 0.3 or less in the 5.0 GHz or higher frequency band 211 that corresponds to IEEE 802.11n/11ac/11ax. Reference numeral 212 denotes a range of the correlation coefficient 0.3±10%. Thus, the first communication unit 54a and the second communication unit 54b normally function as MIMO as independent antennas.

In the case of monopole antennas, the first communication unit 54a and the second communication unit 54b may be separated by a distance of λ/4 or more. However, as described above, even if the spatial distance L1 between the antennas compatible with 5.0 GHz is set to λ/6 and the spatial distance L2 between the antennas compatible with 2.4 GHz is set to λ/12.5, the correlation coefficient is about 0.3 and the antennas operate independently. Thus, separating the first communication unit 54a and the second communication unit 54b by a distance shorter than λ/4, which is generally required, can prevent the size of the digital camera 1 from increasing. In addition, the MIMO communication is usable in practical use without significantly reducing the data amount handled in a certain period.

In a case where priority is given to the size reduction of the digital camera 1, the spatial distance L1 between the antennas compatible with 5.0 GHz may be set to λ/6 and the spatial distance L2 between the antennas compatible with 2.4 GHz may be set to λ/12.5. This is not the case in a case where priority is given to the connection of the correlation coefficient (in a case where the correlation coefficient is set to 0.3 or less). For example, the spatial distance L1 may be set to a range of λ/6 to λ/4, and the spatial distance L2 may be set to a range of λ/12.5 to λ/4.

Referring now to FIG. 8, a description will be given of a structure in which the first communication unit 54a and the second communication unit 54b are housed in the space between the top cover 90 and the antenna cover 91. FIG. 8 is a sectional view taken along a line A-A in FIG. 3A, illustrating the sectional structure of the top cover 90.

In a case where the first communication unit 54a and the second communication unit 54b are arranged with their antennas randomly spaced apart, they cannot be completely covered with the antenna cover 91, and the size of the antenna cover 91 increases, and the overall size of the digital camera 1 increases.

In this embodiment, the first communication unit 54a is disposed so that the substrate surface on which the antenna pattern is wired is orthogonal to the optical axis direction, and the longitudinal direction of the antenna pattern is the same as the longitudinal direction of the digital camera 1 (image sensor 22).

Furthermore, the second communication unit 54b is disposed so that the substrate surface on which the antenna pattern is wired is tilted by 90 degrees relative to the direction orthogonal to the optical axis direction on the basis of the first communication unit 54a, and the longitudinal direction of the antenna pattern is the same as the longitudinal direction of the digital camera 1 (image sensor 22).

The first and second communication units 54a and 54b are arranged so that the substrates of the second and first communication units 54b and 54a do not overlap the extended substrate projection surfaces of the first and second communication units 54a and 54b, respectively. In other words, the first and second communication units 54a and 54b are arranged so that they do not overlap each other when viewed from the direction orthogonal to each of their substrate surface (Z-axis direction and Y-axis direction). In this embodiment, the shake detector 55 is disposed inside the first and second communication units 54a and 54b, and thus the shake detector 55 and the communication unit 54 can be efficiently housed in the space on the object side of the eyepiece unit 16 (EVF unit 29) in the digital camera 1.

A description will now be given of the polarization (polarized wave) direction of the radio (electromagnetic waves) transmitted and received by the communication unit 54. Generally, electromagnetic waves are classified into vertically polarized waves that move vertically and horizontally polarized waves that move horizontally according to the vibration of the electric field that propagates through space. Unless the polarization directions of the transmitted and received waves match, an antenna cannot perform effective data communication, and lowers communication efficiency.

This embodiment tilts the second communication unit 54b relative to the first communication unit 54a, and thereby changes the polarization directions of the first communication unit 54a and the second communication unit 54b and reduces the correlation coefficient. Therefore, even in MIMO, communication is possible without significantly reducing the data amount handled in a certain period.

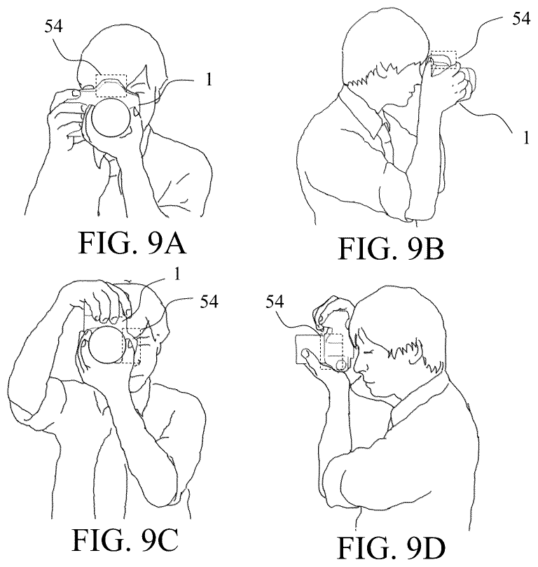

Referring now to FIGS. 9A to 9D, a description will be given of an example of how a user holds the digital camera 1 and captures an object, and how the first communication unit 54a and the second communication unit 54b are unlikely to be covered with the hands. FIGS. 9A to 9D illustrate an example of an orientation in which the digital camera 1 is held. FIG. 9A is a front view of the digital camera 1 horizontally held by a user. FIG. 9B is a side view of the digital camera 1 horizontally held by the user. FIG. 9C is a front view of the digital camera 1 vertically held by the user. FIG. 9D is a side view of the digital camera 1 vertically held by the user.

A typical attitude of a user during imaging is holding the grip portion 82 with his right hand and the lens unit 150 with his left hand, and peeping through the viewfinder (eyepiece unit 16).

In FIGS. 9A and 9B, the communication unit 54 is located at a position on the upper portion of the digital camera 1 that is unlikely to be covered with the user's hand or face. In FIGS. 9C and 9D, the communication unit 54 is located at a position on the side of the digital camera 1 that is unlikely to be covered with the user's hand or face.

Thus, the communication unit 54 is located away from the optical-axis center of the digital camera 1 and on the object side of the eyepiece unit 16. Thus, the communication unit 54 is located in place that is unlikely to be covered with the user's hand or face, and good communication can be provided even in wireless communication during imaging.

### Second Embodiment

In the first embodiment, a plurality of communication units are disposed in place away from the optical-axis center of the image sensor 22 and inside the top cover 90 on the object side of the eyepiece unit 16, which is unlikely to be covered with the user's hand or face while the user holds the digital camera 1 and performs imaging.

This embodiment will discuss a configuration that can provide good MIMO communication using a plurality of communication units without increasing the size of the digital camera 1 in an imaging situation while the user is not holding the digital camera 1.

A spatial distance between the antenna patterns of the first communication unit 54a and the second communication unit 54b and a holding angle are the same as those in the first embodiment. This embodiment will discuss only the configuration different from the first embodiment, and will omit a description of the common configuration.

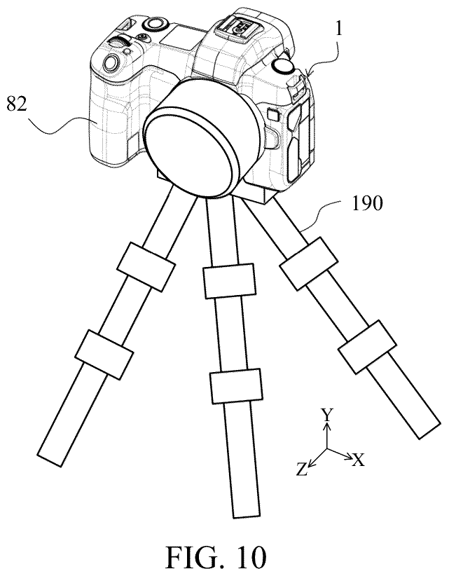

FIG. 10 illustrates the digital camera 1 attached to a tripod 190. In imaging using the digital camera 1, the user may not hold the digital camera 1 but may attach it to a tripod or a pan head and perform imaging using a remote control or wireless communication. In this case, placing the communication unit 54 in the grip portion 82 that protrudes in the digital camera 1 enables good wireless communication without radio waves being blocked by the metal exterior of the digital camera 1 itself or the lens unit 150.

FIG. 11 explains the first communication unit 54a and the second communication unit 54b attached to the grip portion 82.

The main chassis 160 is molded from a conductive material such as conductive resin or magnesium alloy, and a battery 203 is housed inside the main chassis 160.

A front cover 180 is molded from a nonconductive resin material, and is fixed to the main chassis 160 with unillustrated screws. Space is formed between the main chassis 160 and the front cover 180 to house the first communication unit 54a and the second communication unit 54b.

The first communication unit 54a and the second communication unit 54b are directly fixed to the main chassis 160 with the screws 99. The ground pattern 548 of the communication unit 54 is connected to the conductive member of the digital camera 1, and has an electrical characteristic as so-called earth.

A bottom cover 170 is molded from a nonconductive resin material and is an external component that is used in a case where the digital camera 1 is fixed to the tripod 190 or a pan head (not illustrated). The bottom cover 170 has a battery cover 204 from which the battery 203 can be removed.

The first and second communication units 54a and 54b are arranged so that the substrates of the second and first communication units 54b and 54a do not overlap the extended substrate projection surfaces of the first and second communication units 54a and 54b, respectively, and form approximately 90 degrees. At this time, the battery 203 is housed inside the first communication unit 54a and the second communication unit 54b, that is, the battery 203 is disposed in an area where a substrate projection direction of (the first surface of) the first communication unit 54a and a substrate projection direction of (the second surface of) the second communication unit 54b intersect. This structure can efficiently dispose the first communication unit 54a and the second communication unit 54b in the space formed between the main chassis 160 and the front cover 180.

Arranging the first communication unit 54a and the second communication unit 54b at an angle of 90 degrees can change the polarization direction of the first communication unit 54a and the second communication unit 54b and reduce the correlation coefficient. Therefore, even in MIMO, communication is possible without significantly reducing the data amount handled in a certain period.

### Third Embodiment

As in the first embodiment, this embodiment will discuss a structure that arranges a plurality of communication units inside the top cover 90 on the object side of the eyepiece unit 16, which is less likely to be covered with the user's hand or face in a case where the user holds the digital camera 1 and performs imaging. In particular, this embodiment will discuss an antenna attachment structure that improves the correlation coefficient between the antennas by arranging the antennas in a twisted direction and changing the polarization directions (vertical polarization and horizontal polarization). This embodiment will discuss only the configuration that is different from the first embodiment, and will omit a description of the common configuration.

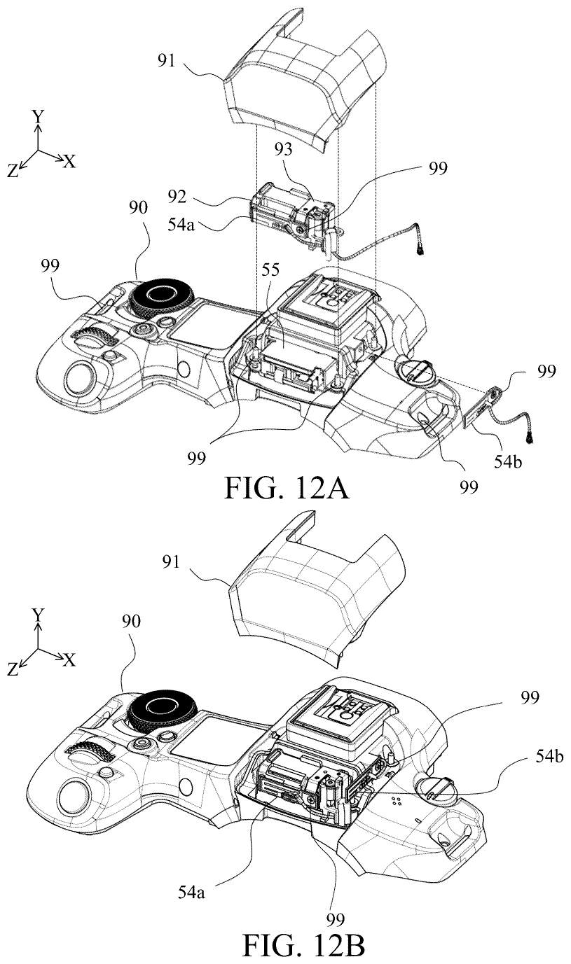

FIGS. 12A and 12B are exploded perspective views illustrating the structure of an image pickup apparatus according to a third embodiment. The top cover 90 is molded from a conductive material such as conductive resin or magnesium alloy, and is connected with the screws 99 to the main chassis 160 (illustrated in FIG. 11) also molded from a conductive material such as conductive resin or magnesium alloy.

The antenna cover 91 is molded from a nonconductive resin material, and is fixed to the top of the top cover 90 with the screws 99. Space is formed between the top cover 90 and the antenna cover 91 to accommodate the first communication unit 54a and the second communication unit 54b.

The first communication unit 54a and the second communication unit 54b enable wireless communication, and are disposed on the object side of the eyepiece unit 16 through which the user views an object.

The first communication unit 54a is disposed so that the substrate surface on which the antenna pattern is wired is orthogonal to the optical axis direction, and its longitudinal direction is the same as the longitudinal direction of the digital camera 1 (image sensor 22).

The second communication unit 54b is disposed so that the substrate surface on which the antenna pattern is wired is tilted by 90 degrees relative to the direction (X-axis direction) orthogonal to the optical axis direction on the basis of the first communication unit 54a, and its longitudinal direction of the antenna pattern is the same as the optical axis direction. A relationship between the first communication unit 54a and the second communication unit 54b may be a so-called twisted relationship.

Disposing the shake detector 55 inside the space that houses the first communication unit 54a and the second communication unit 54b can efficiently house the communication unit 54 and the shake detector 55 in the digital camera 1.

Since the polarization direction is generally determined according to the direction of the current flowing through the antenna, the polarization plane can be changed by tilting the antennas by 90 degrees. This embodiment sets the longitudinal direction of the antenna pattern of the first communication unit 54a to the X-axis direction, and the longitudinal direction of the antenna pattern of the second communication unit 54b to the Z-axis direction, thereby improving the correlation coefficient.

The antenna fixing member 92 is a nonconductive member molded from a nonconductive resin material. The conductive plate 93 is a sheet metal member made of a conductive material such as aluminum alloy, stainless steel, or copper plate. The conductive plate 93 is disposed between the antenna fixing member 92 and the first communication unit 54a, and is fixed with the screws 99 on the upper surface of the first communication unit 54a. At this time, the conductive plate 93 is electrically connected to the first communication unit 54a. In fastening to the top cover 90 with the screws 99, the conductive plate 93 and the first communication unit 54a are electrically connected to the top cover 90. Similarly, the second communication unit 54b is fixed to the top cover 90 with the screws 99, and is electrically connected to the top cover 90.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an image pickup apparatus that enables good communication while suppressing the size increase.

This application claims priority to Japanese Patent Application No. 2024-070698, which was filed on Apr. 24, 2024, and which is hereby incorporated by reference herein in its entirety.

What is claimed is:

1. An image pickup apparatus comprising:
a first member made of a conductive material;
a second member made of a nonconductive material;
a first antenna disposed between the first member and the second member and capable of wireless communication; and
a second antenna disposed between the first member and the second member and capable of the wireless communication,
wherein the first antenna has a first surface that has a first pattern and is orthogonal to an optical axis direction,
wherein the second antenna has a second surface that has a second pattern and is tilted relative to the first surface, and
wherein the first antenna and the second antenna are arranged so that the first antenna and the second antenna do not overlap each other when viewed from the optical axis direction and when viewed from a direction orthogonal to the second surface.

2. The image pickup apparatus according to claim 1, wherein the second surface is tilted relative to the first surface by 90 degrees.

3. The image pickup apparatus according to claim 2, further comprising an image sensor configured to convert an optical image of an object into an electrical signal,
wherein a longitudinal direction of the first pattern is the same as a longitudinal direction of the image sensor, and
wherein a longitudinal direction of the second pattern is the same as the longitudinal direction of the image sensor.

4. The image pickup apparatus according to claim 2, further comprising an image sensor configured to convert an optical image of an object into an electrical signal,
wherein a longitudinal direction of the first pattern is the same as a longitudinal direction of the image sensor, and
wherein a longitudinal direction of the second pattern is the same as the optical axis direction.

5. The image pickup apparatus according to claim 1, wherein the first member is an exterior member, and
wherein the second member is an exterior member partially covering the first member.

6. The image pickup apparatus according to claim 5, further comprising an eyepiece unit,
wherein the first antenna and the second antenna are disposed on an object side of the eyepiece unit.

7. The image pickup apparatus according to claim 5, further comprising a shake detector disposed in an area where the optical axis direction and a direction orthogonal to the second surface intersect.

8. The image pickup apparatus according to claim 1, wherein the first member is a member for fixing the first antenna and the second antenna, and
wherein the first member is an exterior member having a grip portion for a photographer to grip the image pickup apparatus.

9. The image pickup apparatus according to claim 8, further comprising a battery disposed in an area where a projection direction of the first surface and a projection direction of the second surface intersect.

10. The image pickup apparatus according to claim 1, wherein each of the first pattern and the second pattern includes a first antenna pattern and a second antenna pattern, and the first antenna pattern and the second antenna pattern are adjusted to different frequencies.

11. The image pickup apparatus according to claim 10, wherein where λ is a wavelength of a radio wave of a set frequency, a spatial distance between the first antenna pattern of the first pattern and the first antenna pattern of the second pattern falls within a range of λ/6 to λ/4, and a spatial distance between the second antenna pattern of the first pattern and the second antenna pattern of the second pattern falls within a range of λ/12.5 to λ/4.

12. The image pickup apparatus according to claim 1, wherein each of the first antenna and the second antenna is a monopole antenna.
